(19) United States
(12) Patent Application Publication
(10) Pub. No.: US 2022/0247674 A1
(43) Pub. Date: Aug. 4, 2022

(54) SERVICE ROUTING FUNCTION FOR FLEXIBLE PACKET PATH FOR SECURED TRAFFIC

(71) Applicant: Nokia Solutions and Networks Oy, Espoo (FI)

(72) Inventors: Srinivas BANDI, Bangalore (IN); Amal Kumar Appukuttan PILLAI, Bangalore (IN); Narayana CHELUVARAJU, Bangalore (IN); Prashanth ANNARAJAN, Bangalore (IN)

(21) Appl. No.: 17/612,775

(22) PCT Filed: May 19, 2020
(86) PCT No.: PCT/EP2020/063897

§ 371 Date: Nov. 19, 2021

(30) Foreign Application Priority Data
May 21, 2019 (IN) 2019 11020129

(51) Int. Cl. H04L 45/50; H04L 9/40

(52) U.S. Cl. CPC H04L 45/50; H04L 63/166; H04L 63/0485

(57) ABSTRACT

The invention relates to a method and gateways for differentiating traffic path across a transport network, wherein the gateway is involved in performing the method steps of inspecting an inner packet meta-data to create MPLS label stack, encrypting the data packet by applying the IPSec policy and further applying the MPLS labels on the outer packet and routing the packet according to MPLS routing rules.

### FIELD OF THE INVENTION

The present disclosure relates to differentiated routing of secured traffic, and more particularly, to traffic routing in an IPSec network.

### BACKGROUND OF THE INVENTION

The two essential pieces of a telecom network, the Radio Access Network and Core network, are typically connected by a third-party transport network. The mobile traffic is sent via a secure tunnel (IPSec) from the Base station to Core network. An IPSec network consists of a secure tunnel connection made between two endpoints that are being secured. Traffic differentiation—i.e. differentiating packets that travel across a IPSec network is based on traffic policies called child security association (SA), which is based on the tunnel end-point IPs.

This implies that packet routing across the transport network over which the IPSec tunnel is spawned, is purely based on outer IF header (that of the tunnel IP). Any differentiation of routing paths (e.g. based on payload characteristics) or usage of transport resources in general, require information associated with the inner packets. Even in an IP/MPLS based transport network, the Label Switched Path (LSP) is defined based on the tunnel IP header till the peer security gateway. Hence traffic path in the transport network for all security associations (SA) remains the same.

An alternate mechanism is to use separate IPSec tunnels for each kind of traffic, so that each outer IF corresponds to a separate LSP. But this solution does not scale well due to the high number of end-point connections which have to be managed and large number of IF addresses required.

In short, none of the state-of-the-art-solutions offer any flexibility to differentiate traffic paths across the transport network, for example using different label switched paths for different (inner) packets based on their packet properties or meta-data.

One invention that uses some of the technologies and models used in the present invention is detailed in CN102136987A: Message forwarding method and provider edge (PE) equipment for multi-protocol label switching virtual private network (MPLS VP N),

This prior art (original paper in Chinese) seems to map the VPN module with IPsec policy on the customer edge (CE) side with MPLS VPN on provider edge (PE) side. The prior art does not match the scenario or functionality described in our invention, and the unique advantages of proposed art are as follows:
Identifies the right path/route for the secured traffic based on inner IF packet characteristics.
Enables to define multiple paths between same source and destination security gateway for encrypted packet.
No additional steps required in IP/MPLS transport network (which may have PE or P routers).

### Technical Problem

An IPSec network consists of a secure tunnel with tunnels between two end-point IPs with based on policies called child security association (SA)

This implies that packet routing across the transport network over which the IPSec tunnel is spawned, is purely based on outer IP header (that of the tunnel IP). Any differentiation of routing paths (e.g. based on payload characteristics) or usage of transport resources in general, require information associated with the inner packets. Even in an IP/MPLS based transport network, the Label Switched Path (LSP) is defined based on the tunnel IP header till the peer security gateway. Hence traffic path in the transport network for all security associations (SA) remains the same.

It would be better and optimal, if the transport resources are also sliced and separated to form an end-end virtual network for each customer.

### Technical Solution

This invention proposes a mechanism that enables traffic and transport resource differentiation and separation based on traffic policies for the secured traffic flowing between security gateways (an 1 Psec tunnel) in an IP/MPLS transport network.

The security gateway bridges the access and transport networks and it has sufficient knowledge of how to map the access network flows/QoS/slices to those in the transport network by mapping this information along with the IPSec policy to the transport routing path. We utilize this aspect to build the invention.

The invention proposes the following entities: 1A

Service Routing Function (SRF):
It defines the mapping between traffic characteristics of the inner IP (secured) payload to MPLS label stack. The labels are computed based on traffic (inner) packet details (e.g. Layer 3/4 header information such as the five-tuple information or traffic characteristics such as QoS) and preferred routing path. The IP hash—label stack mapping may be stored as a routing table.

2 A service label distribution mechanism either through SDN or as an extension to IKEv2:

An SRF update requires knowledge of transport network topology, slicing model and nature of traffic in radio networks. If an SDN controller manages both devices at the secured ends, label distribution is done any means controlled by the SDN. Otherwise, it may be done using LDP.

In typical telecom deployments, radio network elements like BTS has a built-in IPsec gateway functionality that is not managed by an SDN controller. However, the peer security gateway which is either near to the Core network/edge of transport network are usually managed by an SDN controller. For effective MPLS label distribution and updates across these security gateway functions, it is proposed that is done by the peer security gateway, during the SRF update to edge network element (e.g. BTS) as an 1 KEv2 extension.

Proposed method for packet processing using the present invention:

1. The Service Routing Function (SRF) inspects inner (traffic) packet meta-data and selects possible MPLS label stacks based on it.

2. The packet is encrypted, headers are added (including outer IP) and 1PSec policies are applied (e.g. selection of child SA)

3. Encrypted (IPSec) packets are handed over for further processing (MPLS label application), which is a function of packet characteristics and IPSec policy, after which it is routed according to MPLS routing rules.

### Objective of the Invention

This invention proposes two key mechanisms that provide flexible usage and fine-grained slicing of transport resources that span a single IPSec tunnel:

1. Service routing function (SRF) with configurable and selectable LSP for encrypted (IPsec) traffic in IP/MPLS transport network.

2 Optimized SDN configuration for service label distribution using an extension to IKEv2 protocol.

### SUMMARY OF THE INVENTION

The invention relates to a method and gateways for differentiating traffic path across a transport network, wherein the gateway is involved in performing the method steps of inspecting an inner packet meta-data to create MPLS label stack, encrypting the data packet by applying the IPSec policy and further applying the MPLS labels on the outer packet and routing the packet according to MPLS routing rules.
In one aspect of the invention, the packet details include Layer 3/4 header information such as the five-tuple information or traffic characteristics such as OoS.

In other aspect of the invention, the MPLS labels stack is created by mapping MPLS labels stack with the packet details.

In other aspect of the invention, the preferred routing path is identified on the basis of the (inner) packet details.

In other aspect of the invention, the IPsec policies include selection of a child security associations.

In yet other aspect of the invention, the step of inspecting is done by a service routing function which is created and maintained in at least two gateways of the transport network by a software defined network (SDN) controller or using an IKEv2 extension.

The details of one or more implementations are set forth in the accompanying description below. Other aspects, features and advantages of the subject matter disclosed herein will be apparent from the description and the claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

Features, elements, and aspects of the invention that are referenced by the same numerals in different figures represent the same, equivalent, or similar features, elements, or aspects in accordance with one or more embodiments.

The following figure depicts certain illustrative embodiment of the invention. This depicted embodiment is to be understood as illustrative of the invention and not as limiting in any way.

Referring particularly to the drawing for the purpose of illustration only and not limitation, there is illustrated:

FIG. 1 shows a state-of-the-art IP/MPLS transport network with IPsec as according to an embodiment of the present invention.

FIG. 2 shows packet flow at a secGW with [ER functionality as according to an embodiment of the present invention.

FIG. 3 shows packet flow in secGW after incorporating the invention as according to an embodiment of the present invention.

FIG. 4 shows traffic differentiating in IPsec/IP/MPLS transport network with SRF as according to an embodiment of the present invention.

FIG. 5 shows SRF update with SDN controller as according to an embodiment of the present invention.

FIG. 6 shows SRF update with IKEv2 extension as according to an embodiment of the present invention.

FIG. 7 shows proposed IPsec handshaking with IKEv2 extension as according to an embodiment of the present invention.

### DETAILED DESCRIPTION OF THE INVENTION

As required, an exemplary-only embodiment of the present application is disclosed herein; however, it is to be understood that the disclosed embodiment is merely exemplary of the present disclosure, which may be embodied in various and/or alternative forms. Specific process details disclosed herein are not to be interpreted as limiting, but merely as a basis for the claims and as a representative basis for teaching one skilled in the art to variously employ the present disclosure in virtually any appropriately detailed processes.
Exemplary embodiments may be adapted for many different purposes and are not intended to be limited to the specific exemplary purposes set forth herein. Those skilled in the art would be able to adapt the exemplary-only embodiment of the present disclosure, depending for example, on the intended use of adapted embodiment. Moreover, examples and limitations related therewith brought herein below are intended to be illustrative and not exclusive. Other limitations of the related art will become apparent to those of skill in the art upon a reading of the following specification and a study of the related figures. The invention will be more clearly understood from the following description of the product thereof.

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

This invention proposes a mechanism that enables traffic and transport resource differentiation and separation based on traffic policies for the secured traffic flowing between security gateways (an IPsec tunnel) in an IP/MPLS transport network.

The security gateway bridges the access and transport networks and it has sufficient knowledge of how to map the access network flows/QoS/slices to those in the transport network by mapping this information along with the IPSec policy to the transport routing path. This aspect is utilized to build the invention.

The invention proposes the following entities:

1 A Service Routing Function (SRF):

It defines the mapping between traffic characteristics of the inner IP (secured) payload to MPLS label stack. The labels are computed based on traffic (inner) packet details (e.g. Layer 3/4 header information such as the five-tuple information or traffic characteristics such as QoS) and preferred routing path. The IP hash—label stack mapping may be stored as a routing table.

2. A service label distribution mechanism either through SDN or as an extension to IKEv2:

An SRF update requires knowledge of transport network topology, slicing model and nature of traffic in radio networks. If an SDN controller manages both devices at the secured ends, label distribution is done by any means controlled by the SDN. Otherwise, it may be done using LDP. In typical telecom deployments, radio network elements like BTS has a built-in IPsec gateway functionality that is not managed by an SDN controller. However, the peer security gateway which is either near to the Core network/edge of transport network are usually managed by an SDN controller. For effective MPLS label distribution and updates across these security gateway functions, it is proposed that is done by the peer security gateway, during the SRF update to edge network element (e.g. BTS) as an IKEv2 extension.

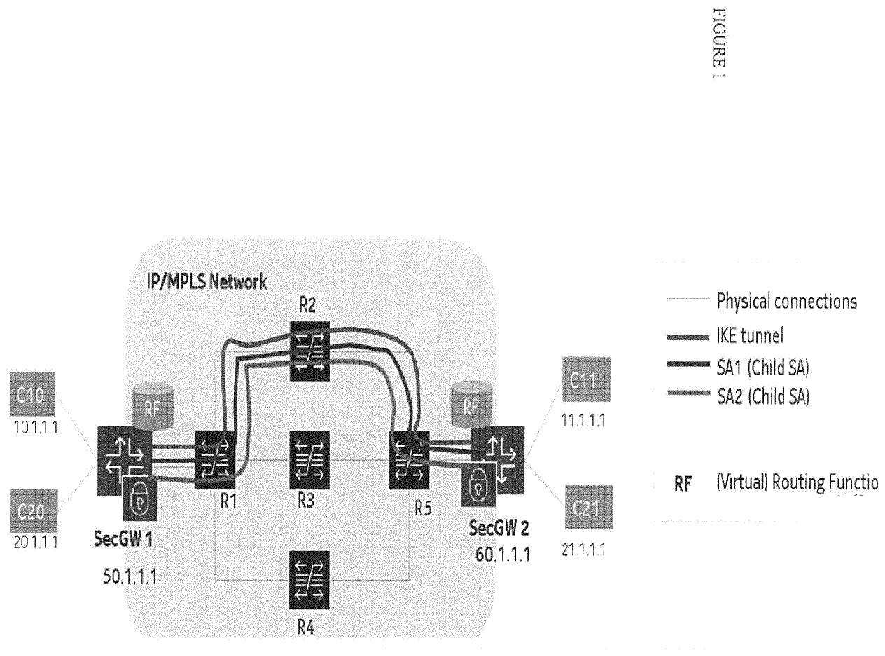

FIG. 1 describes a typical state-of-the-art IP/MPLS system used as the transport network. The MPLS label stack and subsequently the label switched path (LSP) is identified based on the outer/tunnel IP header. Accordingly, the packet is routed in IP/MPLS transport network based on labels till peer security gateway. An example of such an IP/MPLS transport network is shown in FIG. 1 in which CI 0-C11 and C20-021 represent two separate telecom networks spanning a shared IP/MPLS transport network. The traffic flowing across the IP/MPLS network is protected (confidentiality) by IPSec. Different IPSec policies are applied on each network since their traffic characteristics differ—this is done by applying separate child SA-SA1 and SA2—for each network.

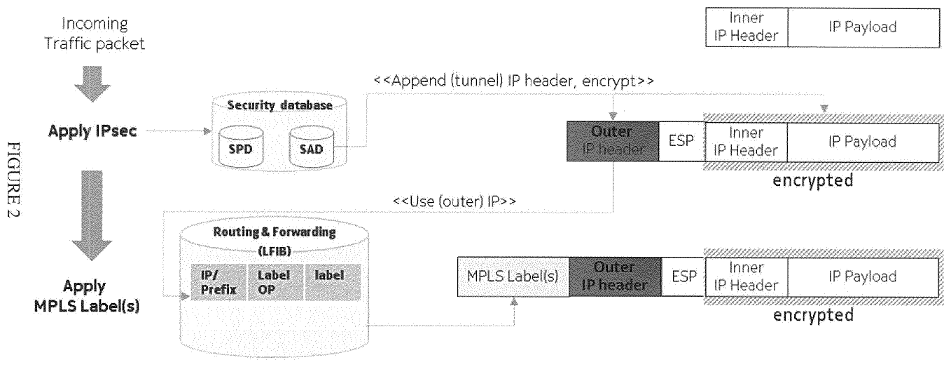

FIG. 2 gives an overview of the traffic packet flow across different functions in security gateway.

The label switched path established for packet routing across the 1PSec connection (and vice-versa) corresponds to the tunnel IP. Usually a security gateway—secGVV1 and secGW2 in this case—is used to setup and manage the IPSec tunnel. The router R1 working as a label edge router ([ER), applies the outgoing label(s) for the packet, that is based on tunnel IP header information. As the tunnel endpoints are identical for both security associations, packets corresponding to both the SAs are routed via single path (via R1-R2-R5) as indicated in FIG. 1.

Although, there are three physical paths (R1-R2-R5, R1-R3-R5 and R1-R4-R5) that can be traversed by the packets, the MPLS labels, based on which IF routing and switching is done, are based on the end-point tunnel IP addresses, which are the same (within the IPSec tunnel), in although traffic policies themselves are different. This implies that the same routing path is used for both the traffic patterns—although it would be better and optimal, if the transport resources are also sliced and separated to form an end-end virtual network for each customer.

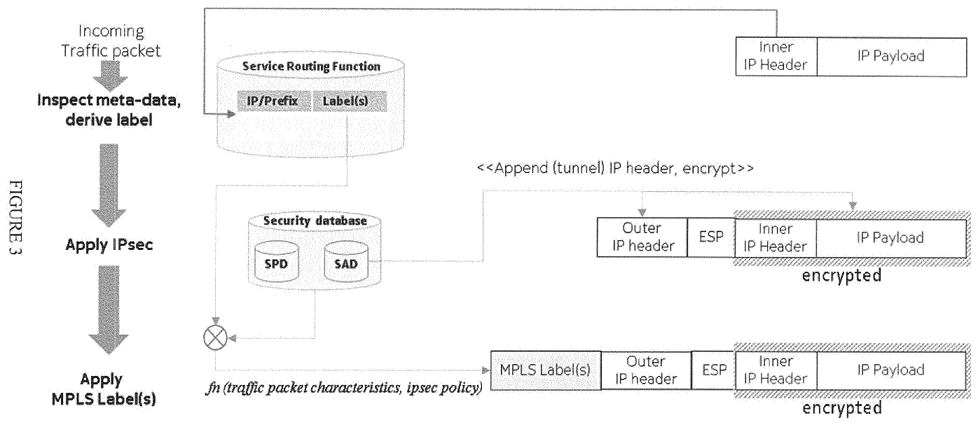

FIG. 3 shows the packet processing once the present invention is applied. It happens in three stages:

1. The Service Routing Function (SRF) inspects inner (traffic) packet meta-data and selects possible MPLS label stacks based on it.

2. The packet is encrypted, headers are added (including outer IP) and IPSec policies are applied (e.g. selection of child SA)

3. Encrypted (IPSec) packets are handed over for further processing (MPLS label application), which is a function of packet characteristics and IPSec policy, after which it is routed according to MPLS routing rules.

The key change in stage 1 (inspect meta-data of traffic packet to create MPLS label stack) along with the selection of IPSec policy (stage 3) allows transport network resource and path differentiation across SAs even when the tunnel end points are the same. The label stack is selected based on inner packet characteristics from the access domain, mapped to the route path and SLA constraints of the transport domain. The SRF is created and maintained in both security gateways by the SDN or using an IKEv2 extension explained in detail later.

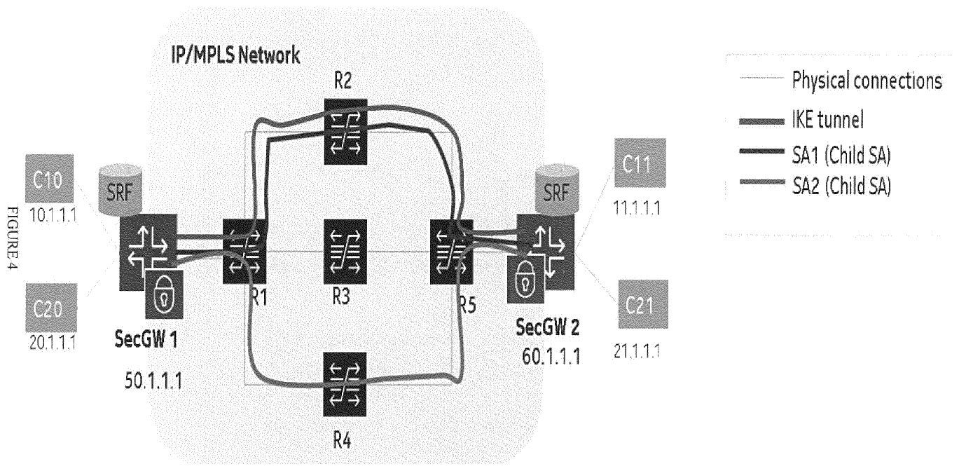

FIG. 4 illustrates this with an example where traffic differentiated for each child SA takes different transport routes viz R1-R2-R5 and R1-R4-R5.

Further, an update to SRF involves the following aspects:

1. IPsec policy configuration to define the tunnel end points for incoming IP traffic. Security association is created based on configured policy.

2. Transport network path computation using a Path Computation Engine (PCE) usually realized as part of SDN controller. The PCE maps the traffic engineering constraints and service characteristics for the inner IP (encrypted) packet to the MPLS label stack (i.e., the LSP) to be considered in the transport network.

3 Configuration of the SRF: SRF update can be done in two mutually exclusive ways:
(a) by the SDN controller if both ends are managed by SDN controller
(b) with IKEv2 extension as described below.

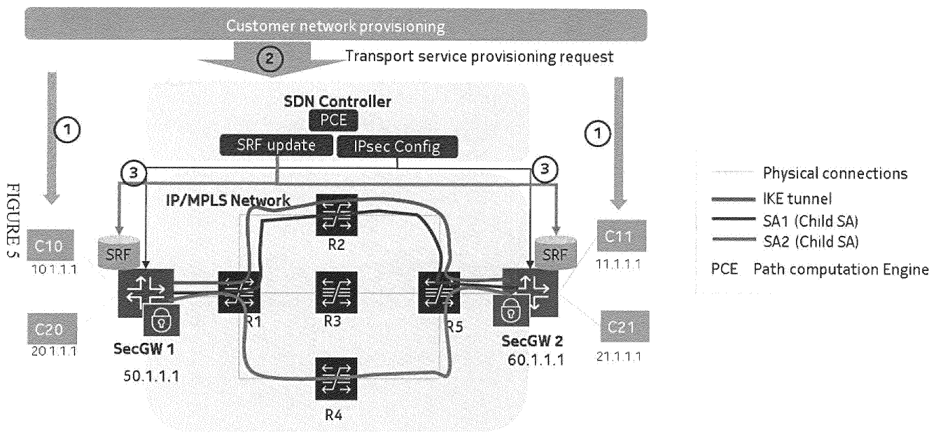

FIG. 5 shows an example where network elements that hold both IPSec endpoints are managed by the same SDN controller.

The SRF update mechanism consists of the following steps:

1. Customer network provisioning system configures parameters such as IF address, Service categorization for customer network elements. Security gateway provides 1Psec functionality for the customer networks.

2. Customer network provisioning system requests SDN controller to create security policies for individual services.

3. SDN controller configures the IPsec policies and updates the SRF on both security gateways.

In case of a change in transport topology, the SDN controller may also update the SRF when it learns the topology change.

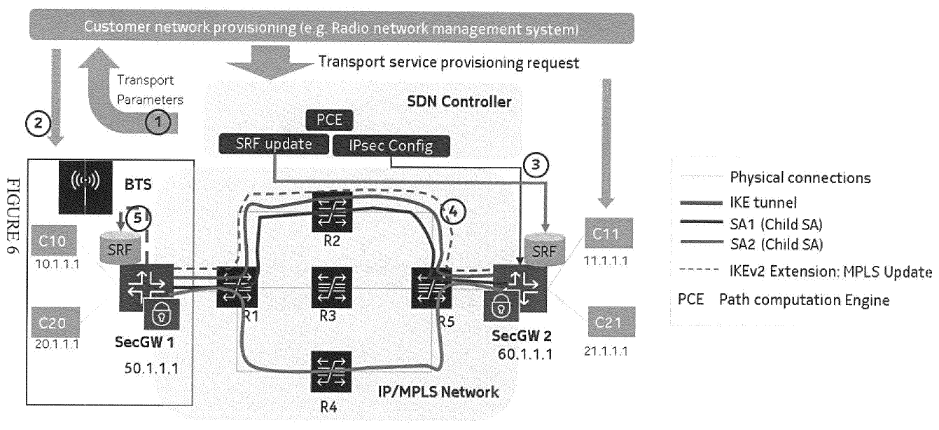

FIG. 6 illustrates a method which may be used when one of the network elements containing the IPSec end-points are managed by different management systems. For example: The SDN controller manages the core end and physical BTS deployments, which are managed by a Radio NMS.

The SRF update mechanism consists of following steps:

1. The SDN controller provides transport configuration parameters such as end-point IF for BTS end and Core end to the customer NMS.

2. Customer NMS configures the IPsec policies to BTS.

3. The SDN controller updates the MPLS label stack for both egress and ingress traffic along with IPsec policies to end-point (secGW #2) which it manages.

4. As a part of child SA establishment procedure, corresponding MPLS label(s) is shared by secGW #2 with secGW #1.

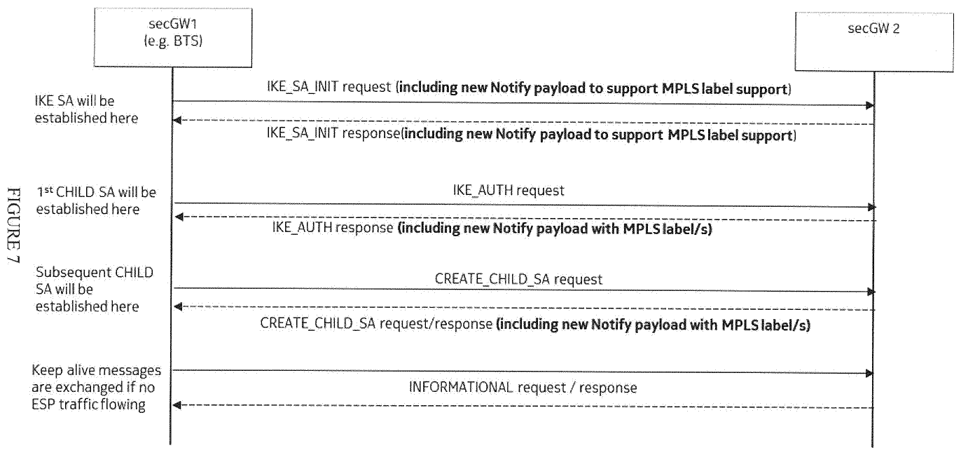

5. secGW #1 updates its local SRF. The IKEv2 extension and its handshake is shown separately in FIG. 7

IKEv2 extensions supporting MPLS label(s) may be proposed as an extension to RFC 5996-https://tools.ietforothtml/r1c5996-to the IETF.

### LIST OF ABBREVIATIONS

BTS Base Transceiver Station
IKE Internet Key Exchange Protocol.
IKEv2 Version 2 of the IKE Protocol
IPsec Internet Protocol Security
LDP Label Distribution Protocol
LER Label Edge Router
LFIB Label Forwarding Information Base LSP Label Switched Path
MPLS Multi-Protocol Label Switching NMS Network Management System PCE Path Computing Engine
QoS Quality of Service
RAN Radio Access Network
SA Security Associations
SAD Security Associations Database SDAP Service Data Adaptation Protocol SDN Software Defined Network
SecGW Security Gateway
S-NSSAI Single Network Slice Selection Assistance Information
SP Security Policy
SPD Security Policy Database SRF Service Routing Function

### Unique Features of the Invention

1. Improved traffic engineering in IP/MPLS transport
a. Flexible packet paths for different ESP traffic type payloads within the same IPSec tunnel, thereby optimizing transport resource utilization within a given transport network.
b. Provides a model for transport network scaling with increased traffic density based on traffic types and multi-tenancy with RAN sharing.

2. Network slicing: Enables transport slicing and slice assignment for different traffic characteristics
a. Mapping S-NSSAI (Single Network Slice Selection Assistance Information) to a specific transport slice at BTS for secure traffic—i.e. SDAP flow/Radio bearer to transport slice mapping.
b. No added complexity in IP Address planning: No additional IF addresses are required for separate tunnels (to separate disparate traffic).

3. Automated end to end service provisioning and management:
a. SRF Provisioning: The SRF is provisioned and configured through SDN and it may be layered over any kind of routing system with minimal adaptation—e.g. IP/MPLS or in future, physical routing such as in a Time Sensitive Network (TSN).
b. Service function chaining in a multi-operator scenario: Different transport service functions may be selected for different operators based on the required services in transport network based on Service Level Agreement (SLA).

The idea can be extended to unsecured traffic spanning different network domains. The radio network handles traffic based on radio discriminants, but this can be continued in transport network, even if the transport network knows nothing about the radio network's discriminants. This is the side-effect of the summing function while applying the MPLS label.

This invention has potential for implementation in the following:

1. Enhance BTS Transport component to
a. map network slices in the radio and transport domain using the SRF.
b. support an L3VPN using the SRF

2. Support end-end transport provisioning and interworking with radio slices by enhancing the SDN controller.

3. Upstream changes to IPsec for host-based solution to Open Source (Linux kernel dev).

The key aspects of this invention may be concluded to be in use within a 3rd party system if one or more the following features are detected:
Different MPLS label(s) mapped to the same tunnel end-point—indicates use of an SRF and traffic separation.
Path computation and label assignment by the SDN controller based on traffic (inner) IP packet details in IPSec deployments.
A handshaking mechanism (e.g. IKE extension or otherwise) across the endpoints for sharing for traffic differentiation (label stack information) of the underlying routing technology (e.g. MPLS).

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

While in the foregoing specification, several embodiments of the invention have been set forth for purposes of making a complete disclosure, it will be apparent to those skilled in the art that numerous changes may be made without departing from the spirit and principles of the invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method for differentiating traffic path across a transport network, the method comprising:
inspecting an inner traffic packet meta-data to create a Multiprotocol Label Switching (MPLS) label stack on the basis of packet details and a preferred routing path;
encrypting the data packet, adding headers to it and applying IPsec policies to it;
applying the MPLS labels based on the inner traffic data packet and the IPsec policies; and
routing the secured (encrypted) data packet according to MPLS routing rules.

2. The method as claimed in claim 1, wherein the packet details include at least one of Layer 3/4 header information such as the quintuple information or traffic characteristics such as QoS.

3. The method as claimed in claim 1, wherein the preferred routing path is identified on the basis of the packet details (meta-data).

4. The method as claimed in claim 1, wherein the header includes an outer IP header.

5. The method as claimed in claim 1, wherein the IPsec policies include selection of a child security association.

6. The method as claimed in claim 1, wherein the step of inspecting is done by a service routing function which is created and maintained in at least two gateways of the transport network by a software defined network (SDN) controller or using an IKEv2 extension.

7. A gateway for differentiating traffic path across a transport network, the gateway comprising:
a service routing function (SRF) for inspecting inner traffic meta data to create and store an MPLS label stack on the basis of packet details and a preferred routing path; and
a processor for encrypting the inner traffic data packet, adding headers and applying IPsec policies, further applying the MPLS labels on the outer packet on the basis of the inner packet details and the IPsec policies and routing the secured (encrypted) traffic data packet according to MPLS routing rules.

8. The gateway as claimed in claim 7, wherein the packet details include at least one of Layer 3/4 header information such as the quintuple information or traffic characteristics such as QoS.

9. The gateway as claimed in claim 8, wherein the preferred routing path is identified on the basis of the packet details.

10. The gateway as claimed in claim 8, wherein the header includes an outer IP header.

11. The gateway as claimed in claim 8, wherein the IPsec policies include selection of a child security association.

12. The gateway as claimed in claim 8, wherein the service routing function is created and maintained in at least two gateways of the transport network by a software defined network (SDN) controller or using an IKEv2 extension.

13. The gateway as claimed in claim 7, wherein the service supports fine grained mapping of radio network slice to transport network slice.
